(19) United States
(12) Patent Application Publication
(10) Pub. No.: US 2011/0227527 A1
(43) Pub. Date: Sep. 22, 2011

(54) Wireless charging kit for portable electronic device

(76) Inventors: Shou Qiang Zhu, Wanchai (HK); Edward Zheng, Wanchai (HK)

(21) Appl. No.: 12/661,708

(22) Filed: Mar. 22, 2010

(51) Int. Cl. H02J 7/00

(52) U.S. Cl. 320/108

(57) ABSTRACT

A wireless charging kit includes a charging pad, a body cover for coupling with the portable electronic device, and a wireless charging arrangement. The wireless charging arrangement includes a first charging module provided at a supporting surface of the charging pad, and a second charging module provided at the body cover. The first charging module has two charging contact points electrically linking to a power source, wherein the second charging module has two charging contact surfaces electrically linking to a rechargeable battery of the portable device, such that the battery is able to be wireless charged via conductively contacting the charging contact surface with the charging contact points in a surface-to-point configuration, so as to simplified the alignment therebetween. The body cover is preferably a replacement of battery cover, so that the add-on component is required in order to wirelessly contact with the first charging module at the charging pad.

### BACKGROUND OF THE PRESENT INVENTION

1. Field of Invention

The present invention relates to an electrical charger, and more particularly to a wireless charging kit for a portable electronic device, which can efficiently charge the portable electronic device by means of electrically conductive contact.

2. Description of Related Arts

Since people rely on technology more and more, the portable electronic devices are commonly and conveniently used, so that human beings are able to carry the devices for using variety of technology applications, such as mobile phone, personal computer, PDA, MP3, or “iPod”. Therefore, how to efficiently restore the electrical energy for the portably devices is one of the main challenging.

A person may own two or more portable electronic devices at the same time. After arrived home, they may have to charge each of the individual devices by plugging into each of the respective device chargers. Therefore, lots of wires for connecting the portable devices to a power source via the plugs may be painful. The user may have to inconveniently match the charger and the device first, and then connect each of the chargers with the power source. The wires of the chargers tend to be tangled together, so that the user trying to take out one of the chargers from a charger storage place, the user has to deal with the massive wires in order to recognize and match the charger with the device.

During traveling, the user may have to bring tons of chargers for charging the variety of personal portable devices. It is not only increasing the luggage size, but also hard to organize the easily tangled wires.

In order to provide a relatively more convenient ways for recharging the portable device and enhancing the portability thereof, a personal charging station is invented for enhancing the convenience of charging portable electronic devices.

One of the common charging stations is the induction type charging station, which normally comprises a charging platform having an induction coil therewithin and only one connecting cable for electrically connecting to the power source, so that when the connecting cable is plugged-in to provide the electric current to the charging platform, an electromagnetic field is generated for wirelessly transferring energy to another electronic devices. Therefore, instead of connecting to a power cable of traditional charger, the electronic devices are able to be conveniently placed on the charging platform, so as to make charge the mobile devices relatively more convenient.

However, in order to seal the induction coil within the charging platform, the overall volume of the charging station tends to be bulky. An add-on receiver is required to electrically attach to the mobile devices for inductive coupling with the charging platform to generate another corresponding electromagnetic field, so that the two electromagnetic fields are formed an electrical transformer for converting the energy into the electrical current for restoring the power to the battery of the portable device. Therefore, the receiver is not only bulky, but also required additional integration or plug-in with each of the portable devices.

Furthermore, the inductive wireless charging station is not efficient in the view of saving power and minimizing the charging time. The inductive charging station does not charge as fast as conventional plug-in charger or other conductive electrical charger and waste more electrical power energy. Therefore, not only does the portable device need to plug in to the add-on receiver, such as a bulky casing or dock, which might be more complicated than traditional plugging-in, but also take up lots of space and waste the electricity.

Another type of charging station is conductive charging station, wherein the conductive charging station comprises a charging station electrically connecting to the power source via one connecting cable. The charging station has a plurality of elongated conductive surfaces, defining a plurality of anode surfaces and cathode surface alternating with the anode surfaces, spacedly and longitudinally formed on the top surface of the charging station. Therefore, when the connecting cable is plugged in for electrically connecting to the power source, the charging station is able to conductively contact with the portable device via an add-on component for restoring power energy within the battery of the device.

However, the add-on component for detachably attaching to the portable device and electrically connecting to the rechargeable batteries is also bulky and thick. Therefore, the additional add-on component is not only protruding out of the portable device to increase the size thereof, but also requiring additional step of integrating or plugging the add-on component with each of the portable devices for electrically connecting to the batteries, which is inconvenient and complicated.

Normally, the add-on component for integrating with the electronic device has at least two protruding terminals for electrically conduct with the respective elongated conductive elements to form a completed circuit for transferring the electrical current to the batteries for recharging. However, the two protruding terminals have to carefully align with respective two opposite poles of anode and cathode of the elongated conductive elements. The point to surface alignment of the two protruding terminals and the elongated conductive elements on the top surface of the charging pad requires the accurate aligning the points to the respective surfaces of the elongated conductive elements, so as to increase the difficulty of the charging operation.

Being easily interrupted during the charging process is another concern of the conductive charging station. The conduction method between the add-on component at the device and the surface of the elongated conductive elements tend to easily and accidentally move the device while charging, so as to lead to the misalignment therebetween to disconnect the charging circuit. In addition, since the add-on component is externally affixed to the electronic device, the electronic device will be rested on the charging station in an unbalancing manner. Especially when the protruding terminals are placed on the top surface of the charging station to electrically conduct with the conductive elements, the unwanted movement of the electronic device will cause the misalignment between the protruding terminals and the conductive elements. The large conductive surface of the elongated conductive elements may also be accidentally touched by human beings, so that the charging circuit is easily interrupted.

### SUMMARY OF THE PRESENT INVENTION

An object of the present invention is to provide a wireless charging kit for a portable electronic device, which can efficiently charge the portable electronic device by means of electrically conductive contact in comparison with the existing wireless induction charger.

Another object of the present invention is to provide a wireless charging kit for a portable electronic device, which comprises a charging pad for the portable electronic device lying thereat and a body cover coupling the portable electronic device to electrically conduct the rechargeable battery of the portable electronic device with the power source.

Another object of the present invention is to provide a wireless charging kit, wherein two charging contact points are located at the charging pad and two corresponding charging contact surfaces are located at the body cover to electrically contact with the charging contact points respectively so as to electrically conduct the rechargeable battery of the portable electronic device with the power source in a surface-to-point contacting configuration.

Another object of the present invention is to provide a wireless charging kit for a portable electronic device, wherein two conductive pathways are embedded at an interior surface the body cover for electrically contacting with two battery contact terminals of the portable electronic device to electrically connect the charging contact surfaces with the rechargeable battery of the portable electronic device. Therefore, the portable electronic device does not require altering its electrical configuration to incorporate with the wireless charging kit of the present invention.

Another object of the present invention is to provide a wireless charging kit for a portable electronic device, wherein the body cover is a replacement of a battery cover of the portable electronic device. Therefore, the user does not require any additional component added on to the portable electronic device in order to electrically conduct with the charging pad.

Another object of the present invention is to provide a wireless charging kit for a portable electronic device, wherein the body cover is relatively thin and small, preferably the thickness thereof is 0.5 mm or less, such that the body cover can be detachably coupled with the portable electronic device without substantially increasing the overall thickness of the portable electronic device.

Another object of the present invention is to provide a wireless charging kit for a portable electronic device, which comprises an alignment arrangement for precisely aligning the charging contact surfaces with the charging contact points respectively in contact manner, so as to ensure the electrical conduction between the portable electronic device and the power source.

Another object of the present invention is to provide a wireless charging kit for a portable electronic device, which can incorporate any portable electronic device having the battery contact terminals or charging outlet.

Another object of the present invention is to provide a wireless charging kit for a portable electronic device, which can be formed home and office wireless charger, travel wireless charger or vehicle wireless charger.

Another object of the present invention is to provide a wireless charging kit for a portable electronic device, which does not require altering the original structural and electrical design of the portable electronic device so as to minimize the manufacturing cost of the wireless charging kit incorporating with the portable electronic device.

Another object of the present invention is to provide a wireless charging kit for a portable electronic device, wherein no expensive or complicated structure is required to employ in the present invention in order to achieve the above mentioned objects. Therefore, the present invention successfully provides an economic and efficient solution for providing a wireless charging configuration for the portable electronic device.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a wireless charging kit for a portable electronic device according to a first preferred embodiment of the present invention.

FIG. 2 is a rear view of the body cover of the wireless charging kit according to the above first preferred embodiment of the present invention.

FIG. 3 is a front view of the body cover of the wireless charging kit according to the above first preferred embodiment of the present invention.

FIG. 4 illustrates the portable electronic device placing on the charging pad that the charging contact points electrically contacting with the charging contact surfaces for charging the rechargeable battery of the portable electronic device according to the above first preferred embodiment of the present invention.

FIG. 5 is an exploded perspective view of a charging adapter of the wireless charging kit according to the above first preferred embodiment of the present invention.

FIG. 6 illustrates the portable electronic device placing on the charging pad that the charging terminal surfaces electrically contacting with the charging contact surfaces for charging the rechargeable battery of the portable electronic device according to the above first preferred embodiment of the present invention.

FIG. 7 is an exploded perspective view of a wireless charging kit according to a second preferred embodiment of the present invention.

FIG. 8 illustrates the portable electronic device placing on the charging pad that the charging contact points electrically contacting with the charging contact surfaces for charging the rechargeable battery of the portable electronic device according to the above second preferred embodiment of the present invention.

FIG. 9 is a perspective view of a wireless charging kit for a portable electronic device according to a third preferred embodiment of the present invention, illustrating the wireless charging kit as a travel kit.

FIG. 10 is a perspective view of the charging pad of the wireless charging kit according to the above third preferred embodiment of the present invention, illustrating the charging pad being folded at its unfolded position.

FIG. 11 is a perspective view of the charging pad of the wireless charging kit according to the above third preferred embodiment of the present invention, illustrating the charging pad being folded at its folded position.

FIG. 12 is a perspective view of a wireless charging kit for a portable electronic device according to a fourth preferred embodiment of the present invention, illustrating the wireless charging kit as a car charging kit.

### DETAILED DESCRIPTION OF THE PREFERRED EMBODIMENT

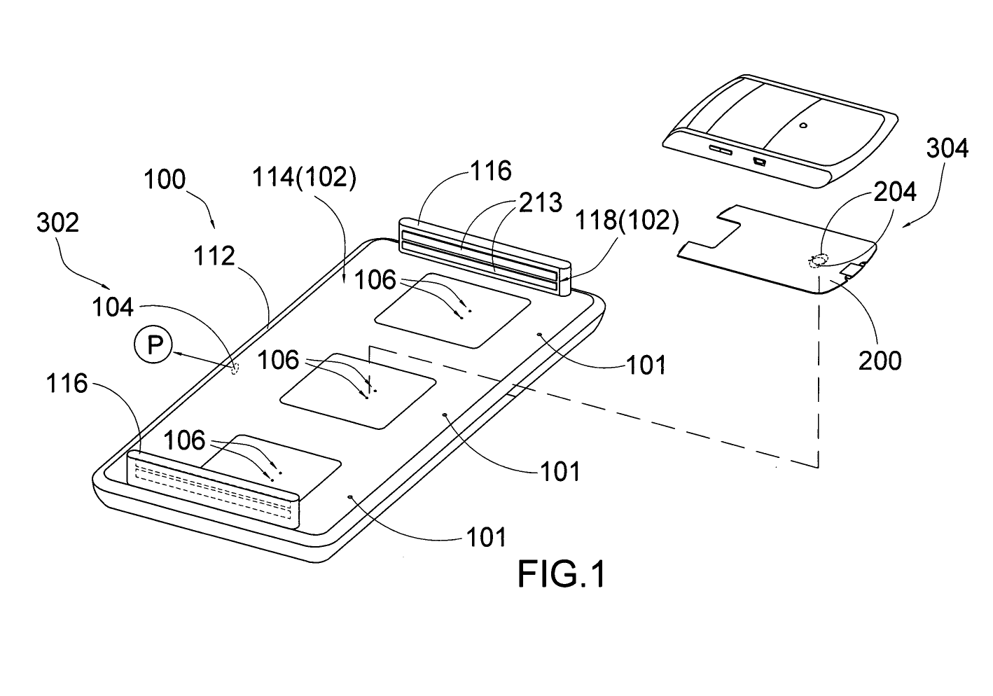

Referring to FIG. 1 of the drawings, a wireless charging kit according to a preferred embodiment of the present invention is illustrated, wherein the wireless charging kit is provided for charging electronic devices with its rechargeable batteries, especially for portable electronic devices, so that the portable electronic devices have no need to individually plug in to an external power source via connecting to a power cable.

The wireless charging kit comprises a charging pad 100, a body cover 200, and a wireless charging arrangement 300, wherein the wireless charging arrangement 300 comprises a first charging module 302 integrated with the charging pad 100 and a second charging module 304 integrated with the body cover 200. Therefore, when the first and second charging module are directly contacted to form a complete charging circuit, the charging kit conductively transfers the electrical energy for charging the portable electronic device.

As shown in FIG. 1, the charging pad 100 has a supporting surface 102 for the portable electronic devices lying thereat. The body cover 200 is adapted for detachably coupling with the portable electronic device to electrically conduct the second charging module 304 with the rechargeable battery of the electronic device, so that when the electronic device is lain at the supporting surface 102 of the charging pad 100, the first charging module 302 at the charging pad 100 is conductively contacting with the second charging module 304 at the cover body 200 for generating an electrical current to charge the rechargeable battery of the portable electronic device in a wireless manner.

The first charging module 302 comprises a power inlet 104 provided at the charging pad 100 for electrically connecting to a power source and at least a pair of charging contact points 106. The two charging contact points 106 are spacedly located at the supporting surface 102 of the charging pad 100 and electrically extended from the power inlet 104.

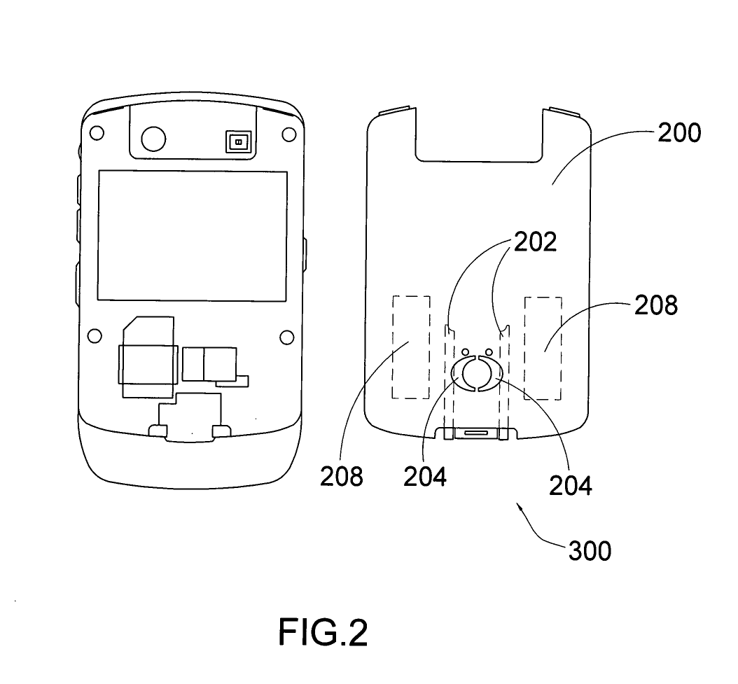

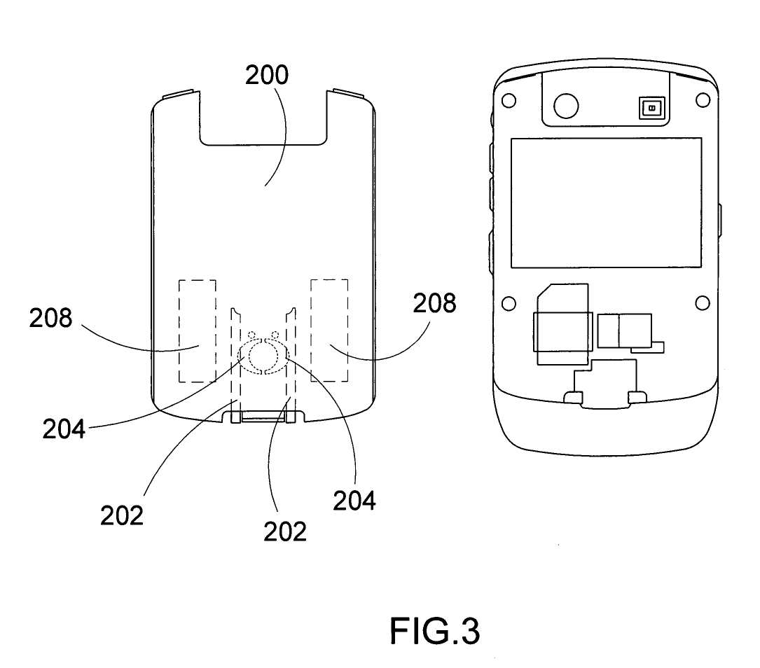

As shown in FIGS. 2 and 3, the second charging module 304 comprises two conductive pathways 202 embedded in the body cover 200 for electrically conducting with the rechargeable battery of the portable electronic device, and two charging contact surfaces 204 extended from the conductive pathways 202 respectively. Therefore, the first and second charging modules 302, 304 are arranged in such a manner that when the body cover 200 is located at the supporting surface 102 of the charging pad 100 at a position that the charging contact surfaces 204 are electrically contacted with the charging contact points 106 respectively, the first charging module 302 is adapted for electrically conducting with the portable electronic device to electrically charge the rechargeable battery of the portable electronic device in the wireless manner.

Accordingly, a method of wirelessly charging the battery of the portable electronic device via the wireless charging kit is further provided, wherein the method comprises the following steps.

(a) Couple the body cover 200 with the portable electronic device at a position that the second charging module 304 is electrically conducted with the rechargeable battery of the portable electronic device.

(b) Place the portable electronic device at the supporting surface 102 of the charging pad 100 at a position that the first charging module 302 is aligned with the second charging module 304.

(c) Electrically contact the two charging contact surfaces 204 of the second charging module 304 with the two charging points 106 at the supporting surface 102 of the charging pad 100. Therefore, the rechargeable battery of the electronic device is electrically linked to the power source for electrically and conductively charge thereof via directly contacting the charging contact surfaces 204 and the two respective charging contact points 106 in the wireless manner.

Accordingly, the two conductive pathways 202 are embedded into the cover body 200 for electrically connecting the rechargeable battery of the electronic device, wherein the two conductive pathways 202 are extended to the charging contact surfaces 204 at the cover body 200 to form an electrical pathway to the rechargeable battery.

As shown in FIGS. 2 and 3, the two pathways 202 are embodied as two conductive wires embedded at an interior surface of the body cover 200 for electrically connecting to two battery contact terminals, anode and cathode, of the portable electronic device. Therefore, the charging contact surfaces 204 and the conductive wires of the conductive pathways 202 are able to integrate with the body cover 200 substantially without protruding portion, so as to minimize the size of the body cover 200.

It is appreciated that the conductive wires of the conductive pathways 202 may be integrated with the body cover 200 by coating at the interior surface of the body cover 200 directly, so that the body cover 200 with the second charging module 304 is able to attach to the electronic device as part of the electronic device, so as to minimize the volume of the second charging module 304.

The two charging contact points 106 are an anode terminal and a cathode terminal respectively. The two charging contact surfaces 204 are electrically connected to an anode and a cathode of the rechargeable battery of the portable electronic device respectively by the two conductive pathways 202, so that when the charging contact surfaces 204 are contacting with the charging contact points 106 respectively, a charging circuit is formed via the first and second charging modules 302, 304 of the wireless charging arrangement 300 for charging the rechargeable battery of the electronic device. It is worth mentioning that the wireless charging arrangement 300 comprises a protection circuit that when the charging contact surfaces 204 are contacted with the charging contact points 106 in an incorrect pole connection, the protection circuit will deactivate the charging circuit to stop charging the rechargeable battery of the electronic device.

It is worth mentioning that the charging contact surfaces 204 at the cover body 200 is provided to align with the charging contact points 106 at the charging pad 100, so that the second charging module 302 is able to align with the first charging module 304 in a surface-to-point manner. Therefore, no accurate alignment action is required for contacting the charging contact points 106 of the first charging module 302 with the charging contact surfaces 204 of the second charging module 304. The electronic device with the body cover 200 is able to conveniently lay at the supporting surface 102 of the charging pad 100 for wirelessly charging the battery of the portable electronic device. The conducting area of the supporting surface 102 for electrically contacting with the second charging module 304 is only at the charging contact points 106 of the charging pad 100, so that the tiny charging contact points 106 also prevent being accidentally touched by human beings or other objects to interrupt or disconnect the charging process.

It is appreciated that the charging pad 100 not only provide the wireless conductive charging method, but also enable one or more portable electronic devices being charged at the same time by one single charger of the wireless charging kit of the present invention via providing two or more pairs of charging contact points 106 at the supporting surface 102 of the charging pad 100.

As shown in FIG. 1, the charging kit of the present invention further comprises an alignment arrangement for precisely aligning the charging contact surfaces 204 with the charging contact points 106 respectively in the contact manner. The alignment arrangement preferably comprises a first magnetic unit 206 provided at the body cover 200 and a second magnetic unit 108 provided at the supporting surface 102 of the charging pad 100.

The first magnetic unit 206 is preferably embedded at the body cover 200 at a predetermined position, and the second magnetic unit 108 provided at the charging pad 100 is located at a predetermined position of the supporting surface 102 in relation to the position of the first magnetic unit 206 for magnetically attracting the magnetic unit 206. Therefore, when the body cover 200 is laid at the supporting surface 102 of the charging pad 100, the first magnetic unit 206 is magnetically attracted with the second magnetic unit 108 for automatically aligning the charging contact surfaces 204 with respective charging contact points 106, so as to ensure the charging contact surfaces 204 being contacted with the charging contact points 106 respectively.

Accordingly, the first and second magnetic units 206, 108 can be two permanent magnets provided at the body cover 200 and the charging pad 100 respectively, wherein the two permanent magnets have corresponding unlike poles facing towards each other for magnetically attraction. Likewise, one of the first and second magnetic units 206, 108 can be a magnetized element while another one can be a magnetically attracting element for magnetically attraction.

As will be appreciated, the surface-to-point arrangement of the charging contact surfaces 204 and the charging contact points 106 and the first and second magnetic units 206, 108 of the alignment arrangement efficiently enhance the convenient of charging portable electronic devices process. The portable electronic device can be easily laid at the supporting surface 102 to conductively contact the first and second charging modules 302, 304 without complicated and frustrated alignment. The first and second magnetic units 206, 108 are able to hold the electronic device in position and to enable the device stably and conductively coupling with the charging pad 100, so that the alignment arrangement effectively prevents the device sliding from the charging pad 100 to damage thereof or accidentally moved to disconnect the charging process.

As mentioned above, the charging contact surfaces 204 at the body cover 200 are two enlarged contact surfaces provided at an exterior surface of the body cover 200 and electrically connecting with the rechargeable battery of the electronic device via the conductive pathways 202 embedded in the cover body 200, such that the enlarged charging contact surfaces 204 have relatively larger alignment area for enhancing the convenient of aligning the first and second charging module 302, 304. Therefore, the charging contact surfaces 204 are relatively easier to contact with the respective charging contact points 106 at the supporting surface 102 of the charging pad 100.

The enlarged charging contact surfaces 204 are preferably formed in arc shape for contacting with the corresponding charging contact points 106 at the supporting surface 102 in a surface-to-point configuration. More specifically, the two contact surfaces 204 are preferably formed a substantially circular arc shaped surfaces, wherein the circular arc shaped charging contact surfaces 204 preferably has a curvature at least 120°. Therefore, the arc shaped charging contact surfaces 204 are formed a geometrical shape for rotatably adjusting the alignment between the charging contact surfaces 204 and the contact points 106, so as to ensure the contact therebetween at all time to prevent the disconnection.

As will be readily appreciated that the two charging contact surfaces 204 can be any other shapes, which have an anode and a cathode respectively for conductively contacting with the corresponding charging contact points 106, so that the rechargeable battery of the portable electronic device is able to be charged via the charging contact surface 204 and the contact points 106 in the wireless configuration.

It is worth to mention that a relative distance, which is substantially a distance of an inner diameter of the circular arc shaped charging contact surfaces, is embodied as 10 mm. Therefore, a distance between the two charging contact points is preferably at least 10 mm in accordance with the relative distance between the two charging contact surfaces 204.

The charging contact surfaces 204 at the exterior surface of the body cover 200 preferably have a thickness no larger than 0.1 mm, such that there is substantially no protruding portion extended out of the exterior surface of the body cover 200. It is not only enhance the aesthetic feelings of the body cover 200 detachably coupled with the electronic device, but also minimize the overall size of body cover 200.

In addition, a charging indicator is provided at the charging pad 100 for indicating the charging status of the portable electronic device, wherein the charging indicator comprises a plurality of light indicators 101 spacedly provided at the charging pad 100 for indicating the charging status of the portable electronic device by different colors.

Accordingly, the step (b) of the method for wireless charging the portable electronic device via the wireless charging kit further comprises the following steps.

(b.1) Embed the first magnetic unit 206 in the body cover 200.

(b.2) Provide the second magnetic unit 108 at the supporting surface 102 of the charging pad 100. The second magnetic unit 108 is preferably integrated with the supporting surface 102 to form a substantially the same plane as the supporting surface 102. The second magnetic unit 108 is able to be as thin as 0.3 mm or less to form at the supporting surface 102.

(b.3) Magnetically attract the second magnetic unit 108 with the first magnetic unit 206. When the body cover 200 is located at the supporting surface 102 of the charging pad 200, the first magnetic unit 206 is magnetically attracted with the second magnetic unit 108 to align and secure the contact between the charging contact surfaces 206 and the charging contact points 108.

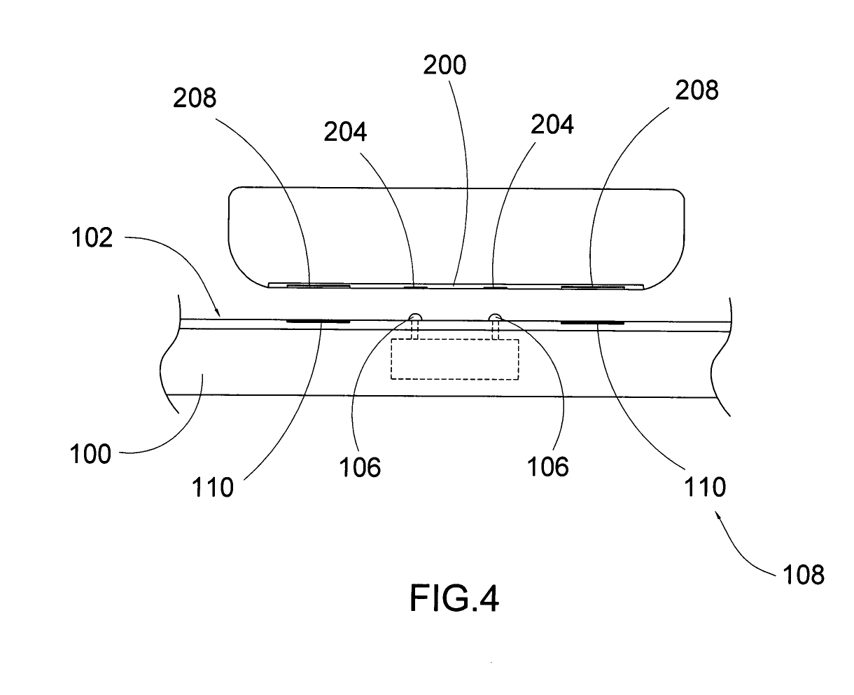

In order to further illustrate the alignment arrangement, the first magnetic unit 206 preferably comprises two first magnetic elements 208 spacedly embedded in the body cover 200 at a position that the two charging contact surfaces 204 is located between the two first magnetic elements 208. Accordingly, the second magnetic unit 108 preferably comprises two second magnetic elements 110 spacedly provided at the supporting surface 102 of the charging pad 100 at a position that the two charging contact points 106 are located between the second magnetic elements 110. Therefore, when the electronic device is laying on the supporting surface 102 of the charging pad 100, the two first and second magnetic elements 208, 110 are magnetically coupling therewith to ensure the conductively contact between the charging contact surfaces 204 and charging contact points 106, as shown in FIG. 4.

In the preferred embodiment, the body cover 200 is preferably a replacement of a battery cover of the portable electronic device. Therefore, the body cover 200 is able to be detachably integrated with the portable electronic device as part of the electronic device. In other words, there is no extra add-on component is needed for coupling with the electronic device, so as to minimize the size thereof and for eliminating a plugging-in operation in order to electrically contact the charging pad 100 with the body cover 200 for charging the rechargeable battery.

Therefore, in step (a) of the method, the body cover 200 is detachably coupling with the portable electronic device by replacing a battery cover of the portable electronic device, so as to form an integrated second charging module 304 with the electronic device.

The body cover 200 is preferably as thin as 0.5 mm or less, so that the body cover 200 with the thin charging contact surfaces 204, preferably 0.1 mm, and the embedded conductive pathways 202 is able to minimize the size of the body cover 200 to form as part of the electronic device. There is substantially no protruding portion of the alignment arrangement or second charging module 304 significantly protruded out of the exterior surface of the body cover 200, so as to minimize the overall size of the body cover 200.

Accordingly, the charging pad 100 of the wireless charging kit preferably comprises a rest station 112, wherein the supporting surface 102 is defined at a top surface 114 of the rest station 112 that the first charging module 302 is provided at the top surface 114 of the rest station 112. Therefore, when the portable electronic device is lying on the top surface 114 of the rest station 112, the second charging module 304 integrated with the body cover 200 is conductively contacting with the first charging module 302 for charging the rechargeable battery of the portable electronic device.

It is worth to mention that the rest station 112 of the charging pad 100 preferably has a thickness of 2.5 mm or less, so that the overall size of the charging kit may be further minimized.

According to the first embodiment, the charging pad 100 further comprises an alignment wall 116 upwardly extended from the rest station 112 to define the supporting surface 102 at a side surface 118 of the alignment wall 116, which is upwardly extended from the top surface 114 of the rest station 112 of the charging pad 100. The first charging module 302 is also provided at the side surface 118 of the alignment wall 116 for electrically and conductively contacting with the second charging module 304 integrated at the body cover 200, such that the charging pad 100 enables relatively more portable electronic devices being charged at the same time.

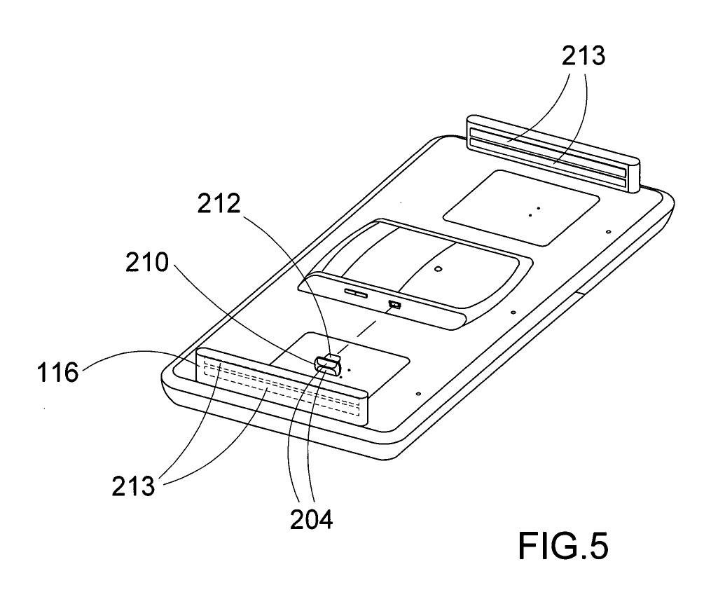

As shown in FIG. 5, the body cover 200 further comprises a charging adapter for electrically coupling with the charging outlet of the portable electronic device, wherein the charging adapter comprises a cover head 210 and a terminal plug 212.

The cover head 210 has an outer side defining the charging contact surfaces 204 thereat. The terminal plug 212 is extended from an inner side of the cover head 210 for detachably coupling with the charging outlet of the portable electronic device, wherein when the terminal plug 212 is detachably plugged into the charging outlet of the portable electronic device, the charging contact surface 204 of the second charging module 304 is electrically connected to the rechargeable battery via the terminal plug 212 for restoring the power energy of the battery.

The terminal plug 212 can be any types of plugs, or connectors, such as mini “USB” connector, for detachably and electrically plugging into a slot or socket of the charging outlet of the portable electronic device, such that the body cover 200 is able to detachably connect to most of the existing electronic devices for conductively contacting the first and second charging modules 302, 304, so as to electrically linking the power source to the electronic device to charge the rechargeable battery in the wireless configuration.

It is worth to mention that the cover head 210 of the body cover 200 is relatively thin and small, so that when the terminal plug 212 is plugging into the charging outlet of the electronic device, the body cover 200 is formed as part of the electronic device for wirelessly and conductively contacting with the first charging module 302.

As shown in FIGS. 1 and 5, the first charging module 302 further comprises two charging terminal surfaces 213 longitudinally extended along the side surface 118 of the alignment wall 116 to conductively contact with the charging contact surfaces 204 at the cover head 210 of the charging adapter. Accordingly, the charging terminal surfaces 213 are the anode terminal surface and the cathode surface parallelly extended along the side surface 118 of the alignment wall 116.

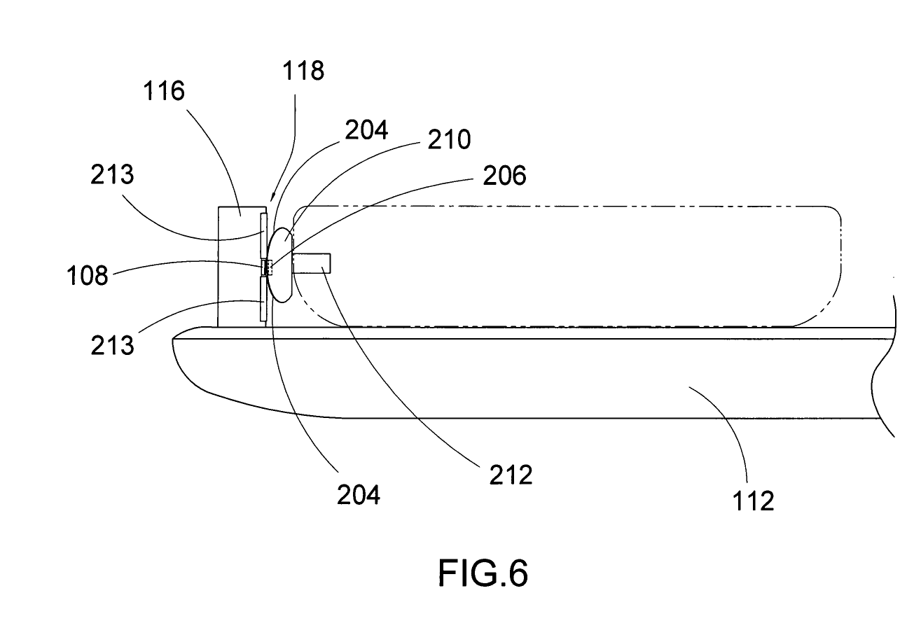

As will be readily appreciated that the portable electronic device is able to lie at the rest station 112 to slidably along the side surface 118 of the alignment wall 116, such that the charging contact surfaces 204 of the body cover 200 is able to alignedly contact with the charging terminal surfaces 213 at the side surface 118 of the alignment wall 116 respectively, as shown in FIG. 6. Therefore, the alignment wall 116 not only provides an additional charging terminal, but also geographically improves the wireless charging configuration for simply charging variety of shapes and types of portable electronic devices. For instance, when the charging outlet may provided at the sidewall of the portable electronic device, the portable electronic device can place on the top surface 114 of the rest station 112 to slide along the alignment wall 116, such that the charging contact surfaces 204 of the body cover 200 will automatically align with the charging terminal surfaces 213 at the side surface 118 of the alignment wall 116 in a conductively contacting manner.

The first and second magnetic units 206, 108 of the alignment arrangement are further embedded at the cover head 210 and the side surface 118 of the alignment wall 116 respectively, so as to magnetically attract each other for aligning the contact surfaces 204 with the charging terminal surfaces 213 respectively. Therefore, the first and second magnetic units 206, 108 are able to magnetically aligning the charging contact surfaces 204 with the charging terminal surfaces 213 at the side surface 118, as shown in FIG. 6.

As will be readily appreciated by one skill in the art, the rest station 108 and the alignment wall 116 of the charging pad 100 are able to be individually provided along to form the charging pad 100 regarding to the purposes and applications of the charging kit. The charging pad 100 may further form a combination of wireless charging kit and portable electronic device holder, such as cell phone, so that the wireless charging kit is able to be mounted in a front panel of the car interior for holding, displaying, and charging one or multiple portable electronic devices via one single wireless charging kit.

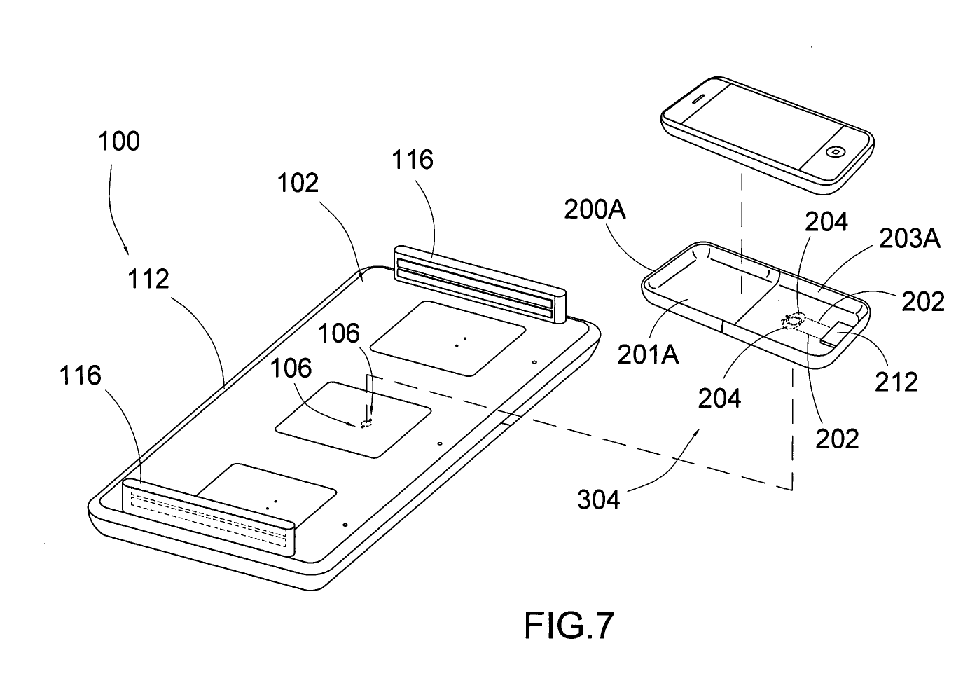

As shown in FIG. 7, a wireless charging kit of a second embodiment illustrates an alternative mode of the first embodiment of the present invention, wherein the charging pad 100 and the wireless charging arrangement 300 are the same as the first embodiment except the body cover 200A.

According to the second embodiment, the body cover 200A comprises detachable casing for detachably coupling with the portable electronic device as an outer sleeve for protection purpose. As shown in FIG. 7, the body cover 200A comprise an upper casing 201A and a lower casing 203A detachably coupling with each other for accommodating the portable electronic device therewithin. The body cover 200A can be a silicon soft case or a plastic hard case to house the portable electronic device therein.

The charging contact surfaces 204 are provided at the rear side of the lower casing 203A of the body cover 20A, wherein the two conductive pathways 202 are embedded in the body cover 200A and are extended from the charging contact surfaces 204 for electrically conducting with the rechargeable battery of the portable electronic device. Therefore, the first and second charging modules 302, 304 are arranged in such a manner that when the body cover 200A is located at the supporting surface 102 of the charging pad 100 at a position that the charging contact surfaces 204 are electrically contacted with the charging contact points 106 respectively, the first charging module 302 is adapted for electrically conducting with the portable electronic device to electrically charge the rechargeable battery of the portable electronic device in the wireless manner.

As shown in FIG. 7, the body cover 200A further comprises a charging adapter supported at the lower casing 203A for electrically coupling with the charging outlet of the portable electronic device, wherein the conductive pathways 202 are extended from the charging contact surfaces 204 to the charging adapter. The charging adapter comprises a terminal plug 212 is extended from an inner side of the lower casing 203A for detachably coupling with the charging outlet of the portable electronic device, wherein the charging contact surface 204 of the second charging module 304 is electrically connected to the rechargeable battery via the terminal plug 212 for restoring the power energy of the battery.

In other words, the body cover 200A is able to be a protective cover detachably covering the portable electronic device for protecting an outer casing of the portable electronic device while providing the second charging module 304 at the body cover 200 in order to wirelessly charge the rechargeable battery of the electronic device.

The second embodiment also illustrates an alternative mode of the alignment arrangement which comprises a first magnetic unit 206A embedded in the body cover 200, preferably at the lower casing 203A thereof, and a second magnetic unit 108A provided at the supporting surface 102 of the charging pad 100.

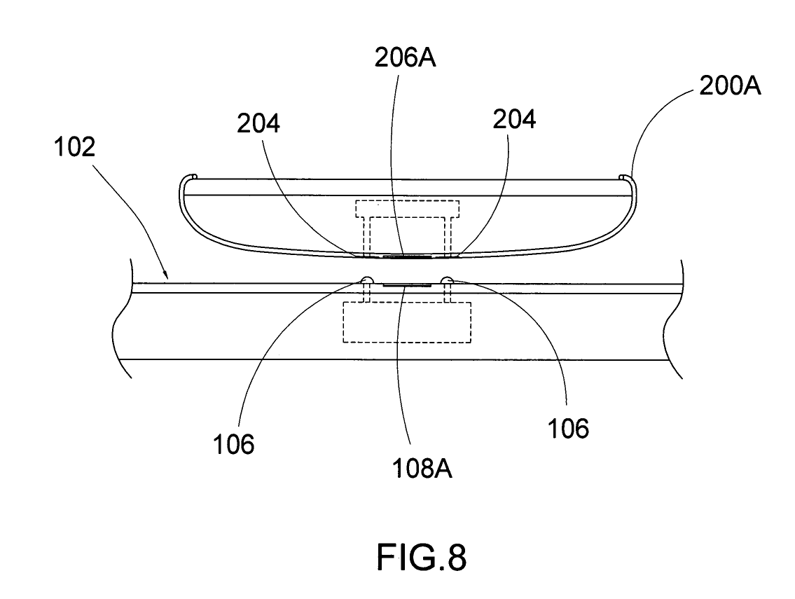

As shown in FIGS. 7 and 8, the first magnetic unit 206A is preferably embedded in the body cover 200A at a position that the charging contact surfaces 204 are coaxially aligned with the first magnetic unit 206A. The second magnetic unit 108A is preferably provided at the supporting surface 102 of the charging pad 100 at a position that the second magnetic unit 108A of the alignment arrangement is located between the charging contact points 106. Therefore, when the first magnetic unit 206A is magnetically attracted with the second magnetic unit 108A, the charging contact points 106 are ensured to conductively contact with the charging contact surfaces 204.

It is worth mentioning that the first magnetic unit 206A is coaxially aligning with the charging contact surfaces 204, such that it enables the second charging module 304 to rotatably adjust the position of the body cover 200A, so as to enhance the convenient of adjusting the alignment between the body cover 200A at the portable electronic device and the supporting surface 102 of the charging pad 100. In other words, the first and second magnetic units 206A, 108A form an alignment center that when the first and second magnetic units 206A, 108A are magnetically attracted with each other, the cover body 200A can be turned around on the supporting surface 102 of the charging pad 100 until the charging contact surfaces 204 are conductively contacted with the charging contact points 106 respectively.

Accordingly, the first magnetic unit 206A may have a predetermined curvature corresponding to the curvature between the two charging contact surfaces 204, wherein the first magnetic unit 206A may be encircled by the two charging contact surfaces 204, so that the body cover 200A is able to be rotatably adjusted to align the charging contact surfaces 204 with the charging contact points 106. It is worth mentioning that the configurations of the alignment arrangements according to the first and second embodiments are interchangeable.

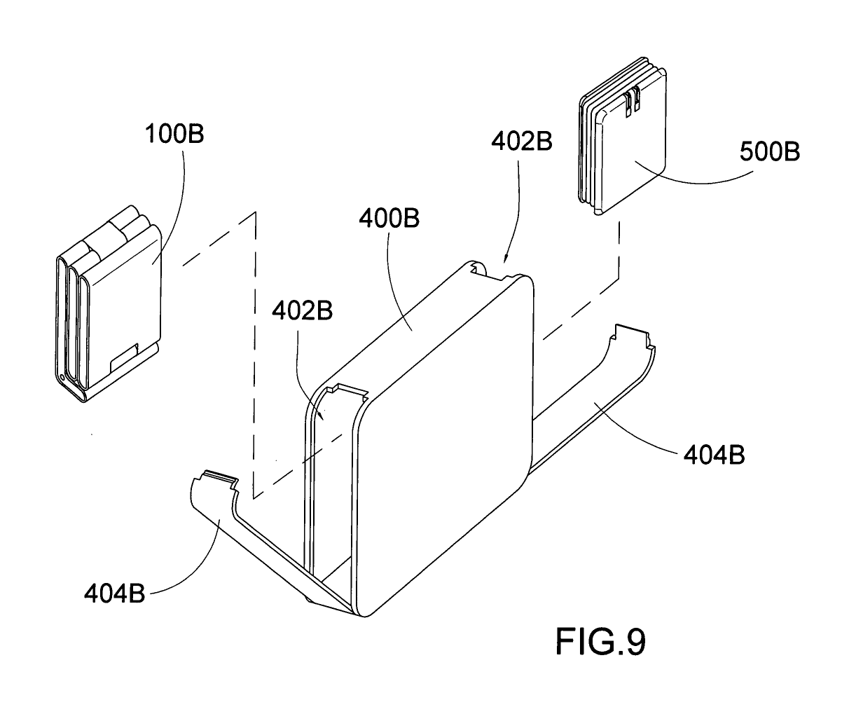

As shown in FIG. 9, a wireless charging kit of a third embodiment illustrates an alternative mode of the first embodiment of the present invention, wherein the body cover 200 and the wireless charging arrangement 300 are the same as the first embodiment except the charging pad 100B. In particularly, the wireless charging kit is embodied as a travel kit.

As shown in FIG. 9, the charging pad 100B comprises a rest station 112B, wherein the supporting surface 102B is defined at a top surface 114B of the rest station 112B that the first charging module 302 is provided at the top surface 114B of the rest station 112B. The charging pad 100B further comprises an alignment wall 116B upwardly extended from the rest station 112B to define the supporting surface 102B at a side surface 118B of the alignment wall 116B, which is upwardly extended from the top surface 114B of the rest station 112B of the charging pad 100B. The first charging module 302 is provided at the top surface 114B of the rest station 112B and the side surface 118 of the alignment wall 116.

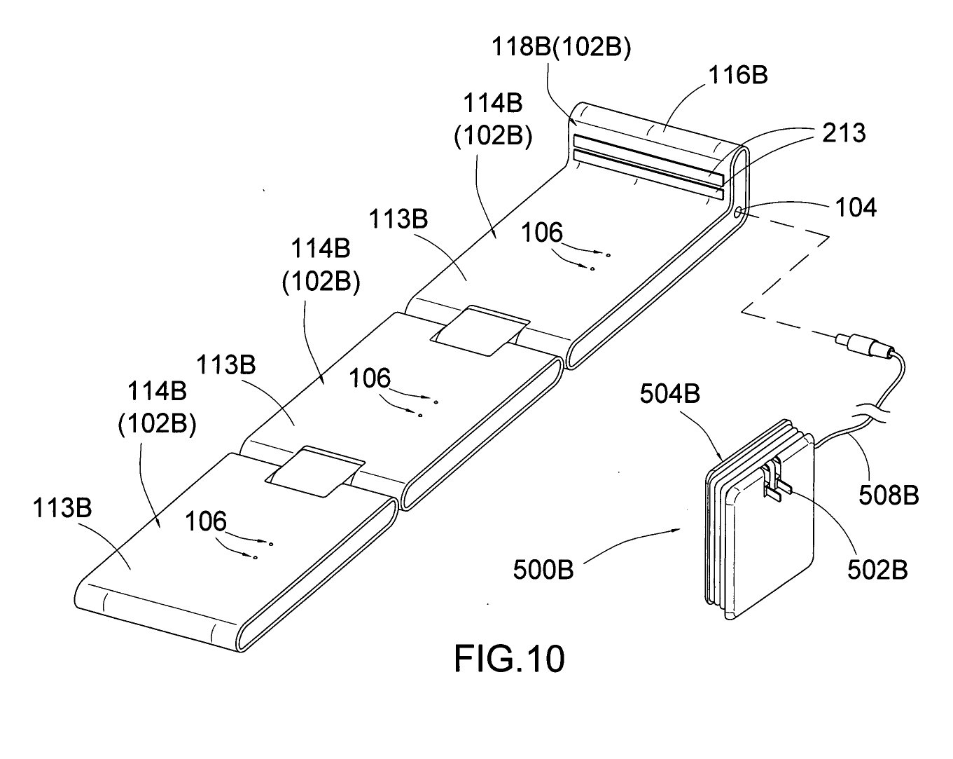

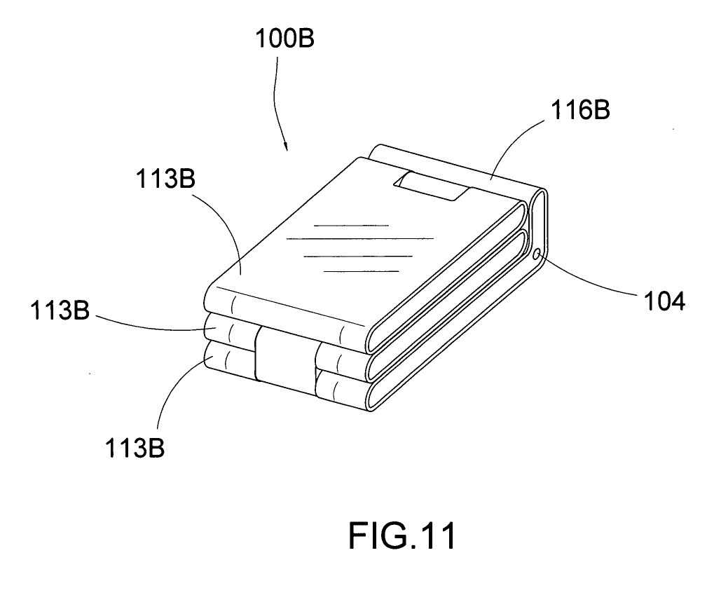

As shown in FIGS. 10 and 11, the rest station 112B comprises a folding structure enabling the rest station 112B being folded between an unfolded position and a folded position. Accordingly, the rest station 112B preferably comprises three supporting platforms 113B foldably coupling with each other edge-to-edge through a plurality of folding joints, wherein the supporting platforms 113B can be tri-folded to its folded position by stacking up the supporting platforms 113B via the folding joints as shown in FIG. 11. The supporting platforms 113B can also be unfolded to align the supporting platforms 113B edge-to-edge to form a flat top surface 114B of the rest station 112B as shown in FIG. 10. Accordingly, the two charging contact points 106 are provided at each of the supporting platforms 113B.

The wireless charging kit, according to the third embodiment, further comprises a traveling housing 400B for receiving the charging pad 100B and a power extension 500B therein for conveniently organizing the charging kit. As shown in FIG. 9, the traveling housing 400B comprises two storage compartments 402B and two pivotal sidewall panels 404B communicating with the storage compartments 402B respectively, wherein when the pivotal sidewall panels 404B are pivotally opened, the folded charging pad 100B and the power extension 500B can be received in the storage compartments 402B respectively.

As shown in FIGS. 9 and 10, the power extension 500B comprises a plug body 502B defining a winding track 504B at an outer circumferential surface of the plug body 502B, a power plug 506B pivotally coupling with the plug body 502B for electrically connecting to a power source, such as a power outlet, and a power cable 508B extended from the plug body 502B to detachably connect to the charging pad 100B and to electrically connect at the power inlet 104 thereat. Accordingly, the power cable 508B can be encirclingly winded around the plug body 502B at the winding track 504B after the power cable 508B is disconnected from the charging pad 100B so as to enable the power extension 500B being received in one of the storage compartments 402B of the traveling housing 400B.

According to the third embodiment, the charging pad 100B can be folded to form a compact size of the charging kit, so that the portability of the charging kit is enhanced. Therefore, the charging kit also enables two or more portable electronic devices being simultaneously charged, wherein a traveler is able to charge multiple devices at the same time to minimize the waiting for charging. The single charging kit also can replace each of specific conventional chargers for each of specific electronic devices, such that the traveler only needs to bring one charging kit instead of multiple chargers.

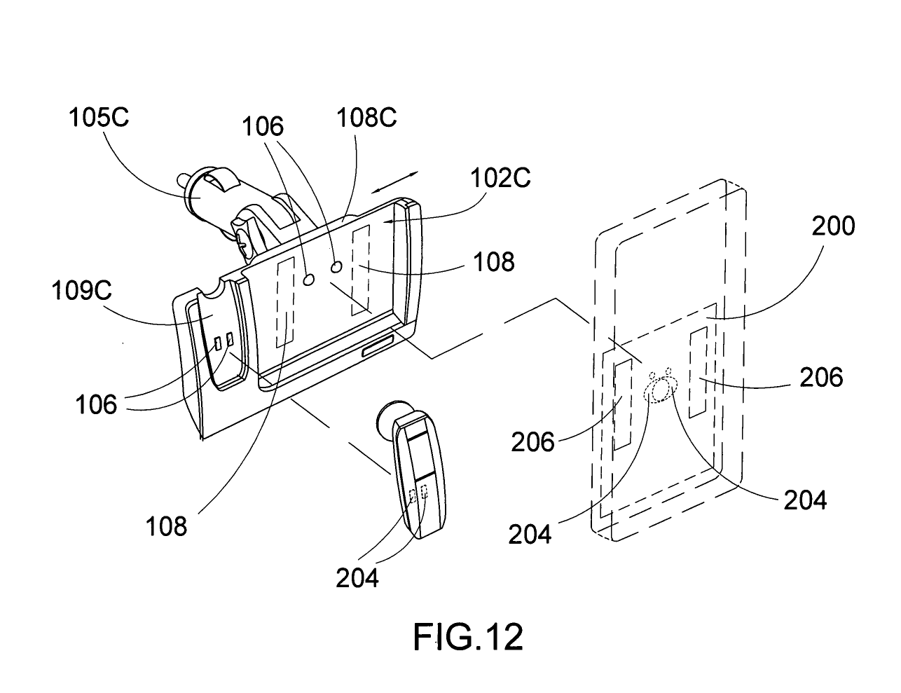

As shown in FIG. 12, a wireless charging kit of a fourth embodiment illustrates an alternative mode of the first embodiment of the present invention, wherein the body cover 200 and the wireless charging arrangement 300 are the same as the first embodiment except the charging pad 100C. In particularly, the wireless charging kit is embodied as a car charging kit.

The charging pad 100C comprises a device holder 108C having a holding cavity for holding the portable electronic device in position, wherein the supporting surface 102C of the charging pad 100C is defined at a front side of the holding cavity of the device holder 108C. For example, the device holder 108C is embodied as a mobile phone holder to hold the mobile phone in position. As shown in FIG. 12, the charging contact points 106 are spacedly located at the front side of the holder cavity of the device holder 108C to conductively contact with the charging contact surfaces 204 located at the rear side of the body cover 200 when the portable electronic device is held at the device holder 108C.

The charging pad 100C further comprises a vehicle power adapter 105C extended from the device holder 108C for electrically connecting with a power outlet of the vehicle.

According to the fourth embodiment, the device holder 108C has a fixed sidewall, a bottom wall, and an opposed adjustable sidewall to define the holding cavity therewithin, wherein the adjustable sidewall can be slidably moved to selectively adjust a distance between the fixed sidewall and the adjustable sidewall in order to fit the portable electronic device at the holding cavity. It is worth mentioning that the first magnetic unit 206 is provided at the body cover 200 and a second magnetic unit 108 is provided at the supporting surface 102C of the charging pad 100C. Therefore, the magnetic attraction between the first and second magnetic units 206, 108 can further hold the portable electronic device at the holding cavity of the device holder 108C.

The charging pad 100C further comprises an accessory holder 109C located adjacent to the device holder 108C to hold an electronic accessory at the accessory holder 109C. As shown in FIG. 12, the electronic accessory can be a “Bluetooth” headset to pair with the mobile phone. In addition, the first and second charging modules 302, 304 can also provided at the accessory holder 109C and the electronic accessory respectively, such that when the electronic accessory is held at the accessory holder 109C, the electronic accessory can be charged at the same time when the portable electronic device is charged.

It is worth mentioning that the two charging terminal surfaces 213 can also be provided at the inner side of the fixed sidewall of the device holder 108C to conductively contact with the charging adapter of the body cover 200 when the portable electronic device is held at the holding cavity of the device holder 108C.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wireless charging kit for a portable electronic device, comprising:
a charging pad having a supporting surface for said portable electronic device lying thereat;
a body cover adapted for coupling said portable electronic device; and
a wireless charging arrangement, which comprises:
a first charging module integrated with said charging pad, wherein said first charging module comprises a power inlet provided at said charging pad for electrically connecting to a power source, and two charging contact points spacedly located at said supporting surface of said charging pad and electrically extended from said power inlet; and
a second charging module integrated with said body cover, wherein said second charging module comprises two conductive pathways embedded in said body cover for electrically conducting with a rechargeable battery of said portable electronic device, and two charging contact surfaces extended from said conductive pathways respectively and arranged in such a manner that when said body cover is located at said supporting surface of said charging pad at a position that said charging contact surfaces are electrically contacted with said charging contact points respectively, said first charging module is adapted for electrically conducting with said portable electronic device to electrically charge said rechargeable battery of said portable electronic device in a wireless manner.

2. The wireless charging kit, as recited in claim 1, further comprising an alignment arrangement for precisely aligning said charging contact surfaces with said charging contact points respectively in contact manner, wherein said alignment arrangement comprises a first magnetic unit embedded in said body cover and a second magnetic unit provided at said supporting surface of said charging pad and magnetically attracting with said first magnetic unit, such that when said body cover is located at said supporting surface of said charging pad, said first magnetic unit is magnetically attracted with said second magnetic unit to ensure said charging contact surfaces being contacted with said charging contact points respectively.

3. The wireless charging kit, as recited in claim 2, wherein said first magnetic unit comprises two first magnetic elements spacedly embedded in said body cover at a position that said charging contact surfaces are located between said first magnetic elements, wherein said second magnetic unit comprises two second magnetic elements spacedly provided at said supporting surface of said charging pad at a position that said charging contact points are located between said second magnetic elements, such that when said first magnetic elements are magnetically attracted with said second magnetic elements respectively, said charging contact points are ensured to contact with said charging contact surfaces for electrically conduction.

4. The wireless charging kit, as recited in claim 2, wherein said first magnetic unit is embedded in said body cover at a position that said charging contact surfaces are coaxially aligned with said first magnetic unit, wherein said second magnetic unit is provided at said supporting surface of said charging pad at a position that said second magnetic unit is located between said charging contact points, such that when said first magnetic unit is magnetically attracted with said second magnetic unit, said charging contact points are ensured to contact with said charging contact surfaces for electrically conduction.

5. The wireless charging kit, as recited in claim 1, wherein said conductive pathways are two conductive wires embedded at an interior surface said body cover for electrically contacting with two battery contact terminals of said portable electronic device.

6. The wireless charging kit, as recited in claim 3, wherein said conductive pathways are two conductive wires embedded at an interior surface said body cover for electrically contacting with two battery contact terminals of said portable electronic device.

7. The wireless charging kit, as recited in claim 4, wherein said conductive pathways are two conductive wires embedded at an interior surface said body cover for electrically contacting with two battery contact terminals of said portable electronic device.

8. The wireless charging kit, as recited in claim 1, wherein said charging contact surfaces are two enlarged contact surfaces provided at an exterior surface of said body cover and are formed in arc shape to contact with said charging contact points respectively in a surface-to-point contacting configuration.

9. The wireless charging kit, as recited in claim 6, wherein said charging contact surfaces are two enlarged contact surfaces provided at an exterior surface of said body cover and are formed in arc shape to contact with said charging contact points respectively in a surface-to-point contacting configuration.

10. The wireless charging kit, as recited in claim 7, wherein said charging contact surfaces are two enlarged contact surfaces provided at an exterior surface of said body cover and are formed in arc shape to contact with said charging contact points respectively in a surface-to-point contacting configuration.

11. The wireless charging kit, as recited in claim 1, wherein said body cover is a replacement of a battery cover of said portable electronic device.

12. The wireless charging kit, as recited in claim 9, wherein said body cover is a replacement of a battery cover of said portable electronic device.

13. The wireless charging kit, as recited in claim 10, wherein said body cover is a replacement of a battery cover of said portable electronic device.

14. The wireless charging kit, as recited in claim 1, wherein said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

15. The wireless charging kit, as recited in claim 12, wherein said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

16. The wireless charging kit, as recited in claim 13, wherein said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

17. The wireless charging kit, as recited in claim 14, wherein said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

18. The wireless charging kit, as recited in claim 15, wherein said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

19. The wireless charging kit, as recited in claim 16, wherein said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

20. The wireless charging kit, as recited in claim 17, wherein said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said first charging module at said side surface of said alignment wall for electrically conducting said portable electronic device.

21. The wireless charging kit, as recited in claim 18, wherein said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said first charging module at said side surface of said alignment wall for electrically conducting said portable electronic device.

22. The wireless charging kit, as recited in claim 19, wherein said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said first charging module at said side surface of said alignment wall for electrically conducting said portable electronic device.

23. The wireless charging kit, as recited in claim 1, wherein said charging pad comprises an alignment wall extended upwardly to define said supporting surface at a side surface of said alignment wall, wherein said first charging module further comprises two charging terminal surfaces longitudinally extended along said side surface of said alignment wall to conductively contact with said charging contact surfaces respectively.

24. The wireless charging kit, as recited in claim 23, wherein said body cover comprises a cover head defining said charging contact surfaces at an outer side of said cover head and a terminal plug extended from an inner side of said cover head for detachably coupling with a charging outlet of said portable electronic device.

25. The wireless charging kit, as recited in claim 24, wherein said conductive pathways are two conductive wires embedded in said cover head and electrically extended from said terminal plug to said charging contact surfaces.

26. A method of wirelessly charging a portable electronic device via a wireless charging kit which comprises a charging pad electrically connecting with a power source, a body cover, and a wireless charging arrangement having first and second charging modules integrated with said charging pad and said body cover respectively, wherein the method comprises the steps of:
(a) coupling said body cover with said portable electronic device at a position that said second charging module is electrically conducted with a rechargeable battery of said portable electronic device;
(b) lying said portable electronic device at a supporting surface of said charging pad at a position that said first charging module is aligned with said second charging module; and
(c) electrically contacting two charging contact surfaces of said second charging module with two charging contact points of said first charging module to electrically conduct with said portable electronic device so as to electrically charge said rechargeable battery of said portable electronic device in a wireless manner.

27. The method, as recited in claim 26, wherein the step (b) further comprises the steps of:
(b.1) embedding a first magnetic unit in said body cover;
(b.2) providing a second magnetic unit at said supporting surface of said charging pad; and
(b.3) magnetically attracting said second magnetic unit with said first magnetic unit, wherein when said body cover is located at said supporting surface of said charging pad, said first magnetic unit is magnetically attracted with said second magnetic unit to ensure said charging contact surfaces being contacted with said charging contact points respectively.

28. The method, as recited in claim 27, wherein said first magnetic unit comprises two first magnetic elements spacedly embedded in said body cover at a position that said charging contact surfaces are located between said first magnetic elements, wherein said second magnetic unit comprises two second magnetic elements spacedly provided at said supporting surface of said charging pad at a position that said charging contact points are located between said second magnetic elements, such that when said first magnetic elements are magnetically attracted with said second magnetic elements respectively, said charging contact points are ensured to contact with said charging contact surfaces for electrically conduction.

29. The method, as recited in claim 27, wherein said first magnetic unit is embedded in said body cover at a position that said charging contact surfaces are coaxially aligned with said first magnetic unit, wherein said second magnetic unit is provided at said supporting surface of said charging pad at a position that said second magnetic unit is located between said charging contact points, such that when said first magnetic unit is magnetically attracted with said second magnetic unit, said charging contact points are ensured to contact with said charging contact surfaces for electrically conduction.

30. The method, as recited in claim 26, wherein the step (a) further comprises a step of embedding two conductive pathways at said body cover that said conductive pathways are extended from said charging contact surfaces to electrically conduct with said rechargeable battery of said portable electronic device.

31. The method, as recited in claim 28, wherein the step (a) further comprises a step of embedding two conductive pathways at said body cover that said conductive pathways are extended from said charging contact surfaces to electrically conduct with said rechargeable battery of said portable electronic device.

32. The method, as recited in claim 29, wherein the step (a) further comprises a step of embedding two conductive pathways at said body cover that said conductive pathways are extended from said charging contact surfaces to electrically conduct with said rechargeable battery of said portable electronic device.

33. The method, as recited in claim 30, wherein said conductive pathways are two conductive wires embedded at an interior surface said body cover for electrically contacting with two battery contact terminals of said portable electronic device.

34. The method, as recited in claim 31, wherein said conductive pathways are two conductive wires embedded at an interior surface said body cover for electrically contacting with two battery contact terminals of said portable electronic device.

35. The method, as recited in claim 32, wherein said conductive pathways are two conductive wires embedded at an interior surface said body cover for electrically contacting with two battery contact terminals of said portable electronic device.

36. The method, as recited in claim 26, wherein said charging contact surfaces are two enlarged contact surfaces provided at an exterior surface of said body cover and are formed in arc shape to contact with said charging contact points respectively in a surface-to-point contacting configuration.

37. The method, as recited in claim 34, wherein said charging contact surfaces are two enlarged contact surfaces provided at an exterior surface of said body cover and are formed in arc shape to contact with said charging contact points respectively in a surface-to-point contacting configuration.

38. The method, as recited in claim 35, wherein said charging contact surfaces are two enlarged contact surfaces provided at an exterior surface of said body cover and are formed in arc shape to contact with said charging contact points respectively in a surface-to-point contacting configuration.

39. The method as recited in claim 26 wherein, in the step (a), said body cover is detachably coupling with said portable electronic device by replacing a battery cover of said portable electronic device.

40. The method as recited in claim 37 wherein, in the step (a), said body cover is detachably coupling with said portable electronic device by replacing a battery cover of said portable electronic device.

41. The method as recited in claim 38 wherein, in the step (a), said body cover is detachably coupling with said portable electronic device by replacing a battery cover of said portable electronic device.

42. The method as recited in claim 26 wherein, in the step (b), said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

43. The method as recited in claim 40 wherein, in the step (b), said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

44. The method as recited in claim 41 wherein, in the step (b), said charging pad comprises a rest station defining said supporting surface at a top surface of said rest station that said first charging module is provided at said top surface of said rest station, such that when said body cover is lain on said top surface of said rest station, said charging contact surfaces are electrically contacted with said charging contact points at said top surface of said rest station for electrically conducting said portable electronic device.

45. The method as recited in claim 42 wherein, in the step (b), said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

46. The method as recited in claim 43 wherein, in the step (b), said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

47. The method as recited in claim 44 wherein, in the step (b), said charging pad further comprises an alignment wall upwardly extended from said rest station and defining said supporting surface at a side surface of said alignment wall extended from said top surface of said rest station, wherein said first charging module further comprises two charging terminal surfaces longitudinally extended along said side surface of said alignment wall to conductively contact with said charging contact surfaces respectively.

48. The method as recited in claim 45 wherein, in the step (a), said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said charging terminal surfaces at said side surface of said alignment wall for electrically conducting said portable electronic device.

49. The method as recited in claim 46 wherein, in the step (a), said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said charging terminal surfaces at said side surface of said alignment wall for electrically conducting said portable electronic device.

50. The method as recited in claim 47 wherein, in the step (a), said body cover comprises a cover head defining said charging contact surfaces at an outer side of said cover head and a terminal plug extended from an inner side of said cover head for detachably coupling with a charging outlet of said portable electronic device, such that when said cover head is lain along said side surface of said alignment wall, said charging contact surfaces are electrically contacted with said charging terminal surfaces at said side surface of said alignment wall for electrically conducting said portable electronic device.

51. The method as recited in claim 26 wherein, in the step (b) said charging pad comprises an alignment wall extended upwardly to define said supporting surface at a side surface of said alignment wall, wherein said first charging module further comprises two charging terminal surfaces longitudinally extended along said side surface of said alignment wall to conductively contact with said charging contact surfaces respectively.

52. The method as recited in claim 51 wherein, in the step (a), said body cover comprises a cover head defining said charging contact surfaces at an outer side of said cover head and a terminal plug extended from an inner side of said cover head for detachably coupling with a charging outlet of said portable electronic device.

53. The method, as recited in claim 52, wherein said conductive pathways are two conductive wires embedded in said cover head and electrically extended from said terminal plug to said charging contact surfaces.

54. A wireless charging kit for a portable electronic device, comprising:
a charging pad having a supporting surface for said portable electronic device lying thereat, wherein a thickness of said charging pad is 2.5 mm or less;
a body cover adapted for coupling said portable electronic device, wherein a thickness of said body cover is 0.5 mm or less; and
a wireless charging arrangement, which comprises:
a first charging module integrated with said charging pad for electrically connecting with a power source; and
a second charging module integrated with said body cover for electrically conducting with a rechargeable battery of said portable electronic device, wherein when said body cover is located at said supporting surface of said charging pad at a position that said second charging module is electrically contacted with said first charging module, said first charging module is adapted for electrically conducting with said portable electronic device to electrically charge said rechargeable battery of said portable electronic device in a wireless manner.

55. The wireless charging kit, as recited in claim 54, wherein said second charging module comprises two conductive pathways embedded in said body cover for electrically conducting with a rechargeable battery of said portable electronic device, and two charging contact surfaces extended from said conductive pathways respectively to electrically contact with said first charging module.

56. The wireless charging kit, as recited in claim 55, wherein a thickness of each of said charging contact surfaces is 0.1 mm or less.

57. The wireless charging kit, as recited in claim 55, wherein a relative distance between said two charging contact surfaces is 10 mm.

58. The wireless charging kit, as recited in claim 54, wherein said first charging module comprises a power inlet provided at said charging pad for electrically connecting to a power source, and two charging contact points spacedly located at said supporting surface of said charging pad and electrically extended from said power inlet to electrically contact with said second charging module.

59. The wireless charging kit, as recited in claim 56, wherein said first charging module comprises a power inlet provided at said charging pad for electrically connecting to a power source, and two charging contact points spacedly located at said supporting surface of said charging pad and electrically extended from said power inlet to electrically contact with said second charging module.

60. The wireless charging kit, as recited in claim 59, wherein a distance between said two charging contact points is 10 mm.

61. The wireless charging kit, as recited in claim 54, further comprising an alignment arrangement for precisely aligning said charging contact surfaces with said charging contact points respectively in contact manner, wherein said alignment arrangement comprises a first magnetic unit embedded in said body cover and a second magnetic unit provided at said supporting surface of said charging pad and magnetically attracting with said first magnetic unit, such that when said body cover is located at said supporting surface of said charging pad, said first magnetic unit is magnetically attracted with said second magnetic unit to ensure said charging contact surfaces being contacted with said charging contact points respectively.

62. The wireless charging kit, as recited in claim 56, further comprising an alignment arrangement for precisely aligning said charging contact surfaces with said charging contact points respectively in contact manner, wherein said alignment arrangement comprises a first magnetic unit embedded in said body cover and a second magnetic unit provided at said supporting surface of said charging pad and magnetically attracting with said first magnetic unit, such that when said body cover is located at said supporting surface of said charging pad, said first magnetic unit is magnetically attracted with said second magnetic unit to ensure said charging contact surfaces being contacted with said charging contact points respectively.

63. The wireless charging kit, as recited in claim 59, further comprising an alignment arrangement for precisely aligning said charging contact surfaces with said charging contact points respectively in contact manner, wherein said alignment arrangement comprises a first magnetic unit embedded in said body cover and a second magnetic unit provided at said supporting surface of said charging pad and magnetically attracting with said first magnetic unit, such that when said body cover is located at said supporting surface of said charging pad, said first magnetic unit is magnetically attracted with said second magnetic unit to ensure said charging contact surfaces being contacted with said charging contact points respectively.

64. The wireless charging kit, as recited in claim 61, wherein a thickness of said first magnetic unit is 0.3 mm or less.

65. The wireless charging kit, as recited in claim 62, wherein a thickness of said first magnetic unit is 0.3 mm or less.

66. The wireless charging kit, as recited in claim 63, wherein a thickness of said first magnetic unit is 0.3 mm or less.

67. The wireless charging kit, as recited in claim 66, wherein said first magnetic unit comprises two first magnetic elements spacedly embedded in said body cover at a position that said charging contact surfaces are located between said first magnetic elements, wherein said second magnetic unit comprises two second magnetic elements spacedly provided at said supporting surface of said charging pad at a position that said charging contact points are located between said second magnetic elements, such that when said first magnetic elements are magnetically attracted with said second magnetic elements respectively, said charging contact points are ensured to contact with said charging contact surfaces for electrically conduction.

68. The wireless charging kit, as recited in claim 66, wherein said first magnetic unit is embedded in said body cover at a position that said charging contact surfaces are coaxially aligned with said first magnetic unit, wherein said second magnetic unit is provided at said supporting surface of said charging pad at a position that said second magnetic unit is located between said charging contact points, such that when said first magnetic unit is magnetically attracted with said second magnetic unit, said charging contact points are ensured to contact with said charging contact surfaces for electrically conduction.

69. The wireless charging kit, as recited in claim 67, wherein said conductive pathways are two conductive wires embedded at an interior surface said body cover for electrically contacting with two battery contact terminals of said portable electronic device.

70. The wireless charging kit, as recited in claim 68, wherein said conductive pathways are two conductive wires embedded at an interior surface said body cover for electrically contacting with two battery contact terminals of said portable electronic device.

71. The wireless charging kit, as recited in claim 69, wherein said charging contact surfaces are two enlarged contact surfaces provided at an exterior surface of said body cover and are formed in arc shape to contact with said charging contact points respectively in a surface-to-point contacting configuration.

72. The wireless charging kit, as recited in claim 68, wherein said charging contact surfaces are two enlarged contact surfaces provided at an exterior surface of said body cover and are formed in arc shape to contact with said charging contact points respectively in a surface-to-point contacting configuration.

73. The wireless charging kit, as recited in claim 71, wherein a curvature of each of said charging contact surfaces is at least 120°.

74. The wireless charging kit, as recited in claim 72, wherein a curvature of each of said charging contact surfaces is at least 120°.

75. The wireless charging kit, as recited in claim 54, wherein said body cover is a replacement of a battery cover of said portable electronic device.

76. The wireless charging kit, as recited in claim 71, wherein said body cover is a replacement of a battery cover of said portable electronic device.

77. The wireless charging kit, as recited in claim 72, wherein said body cover is a replacement of a battery cover of said portable electronic device.

78. The wireless charging kit, as recited in claim 54, wherein said charging pad comprises a rest station defining said supporting surface at a top surface of said rest station that said first charging module is provided at said top surface of said rest station, wherein a thickness of said rest station is 2.5 mm or less.

79. The wireless charging kit, as recited in claim 76, wherein said charging pad comprises a rest station defining said supporting surface at a top surface of said rest station that said first charging module is provided at said top surface of said rest station, wherein a thickness of said rest station is 2.5 mm or less.

80. The wireless charging kit, as recited in claim 77, wherein said charging pad comprises a rest station defining said supporting surface at a top surface of said rest station that said first charging module is provided at said top surface of said rest station, wherein a thickness of said rest station is 2.5 mm or less.
